(19) United States
(12) Patent Application Publication
(10) Pub. No.: US 2013/0194832 A1
(43) Pub. Date: Aug. 1, 2013

(54) CONVERTER DRIVING CIRCUIT, DUAL-MODE LLC RESONANT CONVERTER SYSTEM, AND METHOD OF DRIVING DUAL-MODE LLC RESONANT CONVERTER

(71) Applicants: SAMSUNG ELECTRO-MECHANICS CO., LTD., Gyeonggi-do (KR); University of Seoul Industry Cooperation Foundation, Seoul (KR)

(72) Inventors: Dae Hoon Han, Gyeonggi-do (KR); Kang Yoon Lee, Seoul (KR); Joong Ho Choi, Gyeonggi-do (KR); Hong Jin Kim, Seoul (KR); Joo Hyung Lee, Seoul (KR); Yu Jin Jang, Gyeonggi-do (KR); Jung Chul Gong, Seoul (KR); Jae Shin Lee, Gyeonggi-do (KR)

(73) Assignees: University of Seoul Industry Cooperation Foundation, Seoul (KR); SAMSUNG ELECTRO-MECHANICS CO., LTD, Gyeonggi-do (KR)

(21) Appl. No.: 13/754,812

(22) Filed: Jan. 30, 2013

(30) Foreign Application Priority Data
Jan. 31, 2012 (KR) 10-2012-0009486

(51) Int. Cl. H02M 3/335

(52) U.S. Cl. CPC H02M 3/33507
USPC 363/21.02

(57) ABSTRACT

Disclosed herein are a converter driving circuit for adjusting a variable range of a driving control voltage according to an amplitude and frequency change of a feedback voltage, a dual-mode LLC resonant converter system, and a method of driving the dual-mode LLC resonant converter.

### CROSS REFERENCE(S) TO RELATED APPLICATIONS

This application claims the benefit under 35 U.S.C. Section 119 of Korean Patent Application Serial No. 10-2012-0009486, entitled “Converter Driving Circuit, Dual-Mode LLC Resonant Converter System, and Method of Driving Dual-Mode LLC Resonant Converter” filed on Jan. 31, 2012, which is hereby incorporated by reference in its entirety into this application.

### BACKGROUND OF THE INVENTION

1. Technical Field

The present invention relates to a converter driving circuit, a dual-mode LLC resonant converter system, and a method of driving dual-mode LLC resonant converter.

2. Description of the Related Art

Recently, due to the developments in flat display technologies, large-screen display apparatuses are now being widely used. In particular, along with the development of large-screen display apparatuses such as plasma display panel (PDP) color TV, there is a need to reduce the size and weight of a product but still obtain high power density, high efficiency properties, and low power effect. To satisfy these needs, zero voltage switching (ZVS) DC/DC converters of various types have been suggested.

To obtain high power density and high efficiency properties and to simultaneously reduce power consumption, research is being actively conducted on a 2^{nd} dual-mode feedback LLC resonant converter including a master stage and a slave stage at a secondary side.

A conventional LLC resonant converter is a single-output system for adjusting an output gain according to a switching frequency. On the other end, the dual-mode feedback LLC resonant converter is a multi-output system for adjusting an output gain according to a switching frequency and a duty ratio of a switching control signal. That is, output of a secondary master stage varies according to the switching frequency and output of a secondary slave stage varies according to the duty ratio.

With regard to the dual-mode feedback LLC resonant converter, an output gain of the master stage is obtained by changing the switching frequency, and accordingly, optimal power supply may be effectively performed in response to a change in load. In addition, an output gain of the slave stage may be obtained by changing the duty ratio of the switching control signal. Accordingly, since an output gain may be controlled by using both the switching frequency and the duty ratio, the dual-mode feedback LLC resonant converter may have improved efficiency and low power consumption compared to the conventional LLC resonant converter.

The dual-mode feedback LLC resonant converter uses a driving control voltage in order to adjust the duty ratio of the switching control signal. The driving control voltage is generated according to a comparison result between a preset reference voltage and a voltage transmitted as feedback from a secondary side of the converter.

For example, when the feedback voltage is greater than the reference voltage, the driving control voltage is increased. Accordingly, the duty ratio is adjusted and an output voltage of the slave stage is reduced.

On the other hand, when the feedback voltage is smaller than the reference voltage, the driving control voltage is reduced. Accordingly, the duty ratio is adjusted and the output voltage of the slave stage is increased.

However, if load of the secondary slave stage enters a no-load state, the feedback voltage is increased and the duty ratio is excessively skewed to one side. Accordingly, as the master stage controlled according to a frequency of the secondary side is affected, the duty ratio is further seriously skewed.

If load of the secondary slave stage enters an overload state, the feedback voltage is reduced and the duty ratio is excessively skewed to the other side. Accordingly, as the master stage controlled according to a frequency of the secondary side is affected, the frequency is changed.

Likewise, in a conventional method of controlling the duty ratio by using the driving control voltage, when load of the secondary slave stage is remarkably changed, the stability of a system may not be maintained.

To overcome this problem, technologies for limiting a variable range of the driving control voltage to a predetermined range have been suggested. In this case, conventionally, the variable range of the driving control voltage is limited between fixed maximum and minimum values.

However, when the variable range of the driving control voltage is limited to a fixed range, a change in frequency may not be appropriately reflected.

For example, when a frequency is relatively low, the driving control voltage varies with a relatively wide range, and a change in load and a change in system are reflected, thereby further increasing the efficiency of the system. However, if the various range of the driving control voltage is fixed regardless of a change in frequency, there is a limit in maximizing the efficiency of the system.

On the other hand, when a frequency is relatively high, the variable range of the driving control voltage needs to be further reduced for a stable operation of the system. However, in the dual-mode feedback LLC resonant converter whose variable range of the driving control voltage is fixed, even if a frequency is remarkably increased, the driving control voltage is change in a usual variable range, the stability of the system is reduced.

These problems impede application of conventional dual-mode feedback LLC resonant converters to various electronic apparatuses.

### RELATED ART DOCUMENT

### Patent Document

(Patent Document 1) Korean Patent Publication No. 10-1053278

### SUMMARY OF THE INVENTION

An object of the present invention is to provide a converter driving circuit for adjusting a variable range of a driving control voltage according to an amplitude and frequency change of a feedback voltage, a dual-mode LLC resonant converter system, and a method of driving the dual-mode LLC resonant converter.

According to an exemplary embodiment of the present invention, there is provided a converter driving circuit for driving a dual-mode LLC resonant converter, including a feedback voltage sensing unit that feed-back a voltage output from the dual-mode LLC resonant converter; a driving control voltage generating unit that is connected to the feedback voltage sensing unit and generates a driving control voltage by using the feedback voltage; a driving control voltage limit variable setting unit that is connected to the driving control voltage generating unit and generates an upper limit voltage and a lower limit voltage that limit a variable range of the driving control voltage; and a clock generating unit that is connected to the driving control voltage generating unit, receives the driving control voltage, and generates switch control signals for respectively controlling on/off of switches of the dual-mode LLC resonant converter, wherein the upper limit voltage and the lower limit voltage vary by reflecting a change in the driving control voltage.

The driving control voltage limit variable setting unit may include a limit voltage generating unit that receives a limit determining voltage and generates the upper limit voltage and the lower limit voltage; a control current generating unit that receives the limit determining voltage as feedback and generates a control current; a control frequency signal generating unit that is connected to the control current generating unit, compares the control current with the driving control voltage, and generates a control frequency signal; a reference frequency signal generating unit that generates a reference frequency signal; and a limit determining voltage controller that is connected to the control frequency signal generating unit and the reference frequency signal generating unit, compares the control frequency signal with the reference frequency signal, and adjusts the limit determining voltage.

The driving control voltage limit variable setting unit may further include a reference current generating unit that is connected to the reference frequency signal generating unit and generates a reference current regardless of a change in the limit determining voltage, and the reference frequency signal generating unit may compare the reference current output from the reference current generating unit with the driving control voltage, and may generate a reference frequency signal.

The limit determining voltage controller may include a phase-frequency comparator that receives each of the control frequency signal and the reference frequency signal, compares phases differences and frequencies of the control frequency signal and the reference frequency signal with each other, and outputs the comparison result; and a limit determining voltage generating unit that receives a signal output from the phase-frequency comparator and generates the limit determining voltage.

The phase-frequency comparator may include a first input terminal connected to the control frequency signal generating unit; a second input terminal connected to the reference frequency signal generating unit; a first output terminal that outputs a high signal by a relative difference between a phase and a frequency when a reference frequency is greater than a control frequency; and a second output terminal that outputs a high signal by a relative difference between a phase and a frequency when a reference frequency is smaller than a control frequency.

The limit determining voltage generating unit may increase the limit determining voltage while the high signal is applied from the first output terminal, and may reduce the limit determining voltage while the high signal is applied from the second output terminal.

The limit voltage generating unit may increase the upper limit voltage and reduces the lower limit voltage when the limit determining voltage increases, and may reduce the upper limit voltage and increases the lower limit voltage when the limit determining voltage reduces.

The limit voltage generating unit may include a third amplifier having a first terminal to which the limit determining voltage is applied; a fourth transistor having a control terminal to which an output terminal of the third amplifier is connected; a fifth resistor having one end connected to a first terminal of the fourth transistor, and the other end connected to a second terminal of the third amplifier; a sixth resistor having one end connected to the other end of the fifth resistor, and the other end that is grounded; a second current mirror having one end connected to the second terminal of the fourth transistor, and a first another end to which a terminal for outputting the lower limit voltage is connected; a third current mirror having one end connected to a second another end of the second current mirror, and the other end connected to a terminal for outputting the upper limit voltage is connected; a seventh resistor having one end connected to the first another end of the second current mirror, and the other end that is grounded; and an eighth resistor having one end connected to the other end of the third current mirror.

The control current generating unit may include a first transistor having a control terminal to which the limit determining voltage is applied; a first resistor having one end connected to a first terminal of the first transistor; a second resistor having one end connected to a second terminal of the first transistor, and the other end that is grounded; a second transistor having a first terminal to which the first resistor is connected; a first amplifier having an output terminal connected to a control terminal of the second transistor, a first terminal to which a preset first reference voltage is applied, and a second terminal connected to the first terminal of the second transistor; a third resistor having one end connected to the first terminal of the second transistor, and the other end that is grounded; and a first current mirror having one end connected to a second terminal of the second transistor, and the other end for outputting the control current.

The control frequency signal generating unit may include an input terminal that receives the control current; a first capacitor having one end connected to the input terminal, and the other end that is grounded; a third transistor having a first terminal connected to one end of the first capacitor, and a second terminal that is grounded; a first comparator having a first terminal connected to one end of the first capacitor, a second terminal to which a preset second reference voltage is applied, and an output terminal connected to a control terminal of the third transistor; and a second comparator having a first terminal connected to one end of the first capacitor, a second terminal to which the driving control voltage is applied, and an output terminal for outputting the control frequency signal.

The reference frequency signal generating unit may include an input terminal that receives the reference current; a first capacitor having one end connected to the input terminal, and the other end that is grounded; a third transistor having a first terminal connected to one end of the first capacitor, and a second terminal that is grounded; a first comparator having a first terminal connected to one end of the first capacitor, a second terminal to which a preset second reference voltage is applied, and an output terminal connected to a control terminal of the third transistor; and a second comparator that has a first terminal connected to one end of the first capacitor, a second terminal to which the driving control voltage is applied, and an output terminal for outputting the reference frequency signal.

According to another exemplary embodiment of the present invention, there is provided a dual-mode LLC resonant converter system, including the above-described converter driving circuit; a dual-mode LLC resonant converter that includes a switch for receiving a switch control signal output from the converter driving circuit; and a power supply unit that supplies power to the dual-mode LLC resonant converter.

According to another exemplary embodiment of the present invention, there is provided a method of driving a dual-mode LLC resonant converter, the method including: feeding-back a voltage output from the dual-mode LLC resonant converter to generate a driving control voltage; and controlling on/off of switches of the dual-mode LLC resonant converter by using the driving control voltage, wherein a variable range of the driving control voltage is limited to a range between an upper limit voltage and a lower limit voltage varied by reflecting a change in the driving control voltage.

In this case, the upper limit voltage and the lower limit voltage may be determined according to a limit determining voltage, wherein the limit determining voltage is generated by: comparing a control current to which a change in the limit determining voltage is reflected with the driving control voltage to generate a control frequency signal; and comparing phase differences and frequencies of a preset reference frequency signal and the control frequency signal with each other.

The reference frequency signal may be generated by comparing a reference current that is not related to the change in the limit determining voltage with the driving control voltage.

The limit determining voltage may be generated by a PLL loop.

The upper limit voltage and the lower limit voltage may vary in such a manner that the upper limit voltage is increased and the lower limit voltage is reduced when the limit determining voltage increases, and the upper limit voltage is reduced and the lower limit voltage is increased when the limit determining voltage is reduced.

### BRIEF DESCRIPTION OF THE DRAWINGS

FIG. 1 is a circuit diagram of a dual-mode LLC resonant converter system according to an embodiment of the present invention;

FIG. 2 is a block diagram of a converter driving circuit, according to an embodiment of the present invention;

FIG. 3 is a block diagram of a driving control voltage limit variable setting unit according to an embodiment of the present invention;

FIG. 4 is a circuit diagram of a control current generating unit according to an embodiment of the present invention;

FIG. 5 is a circuit diagram of a reference current generating unit according to an embodiment of the present invention;

FIG. 6 is a circuit diagram of a frequency signal generating unit according to an embodiment of the present invention;

FIG. 7 is a diagram for describing an operating principle of a circuit of FIG. 6, according to an embodiment of the present invention;

FIG. 8 is a circuit diagram of a phase-frequency comparing unit according to an embodiment of the present invention;

FIG. 9 is a circuit diagram of a limit determining voltage generating unit according to an embodiment of the present invention;

FIGS. 10A and 10B are diagrams for describing a generating principle of a limit determining voltage, according to an embodiment of the present invention;

FIG. 11 is a circuit diagram of a limit voltage generating unit according to an embodiment of the present invention; and

FIGS. 12A and 12B are diagrams for describing a generating principle of a limit voltage, according to an embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

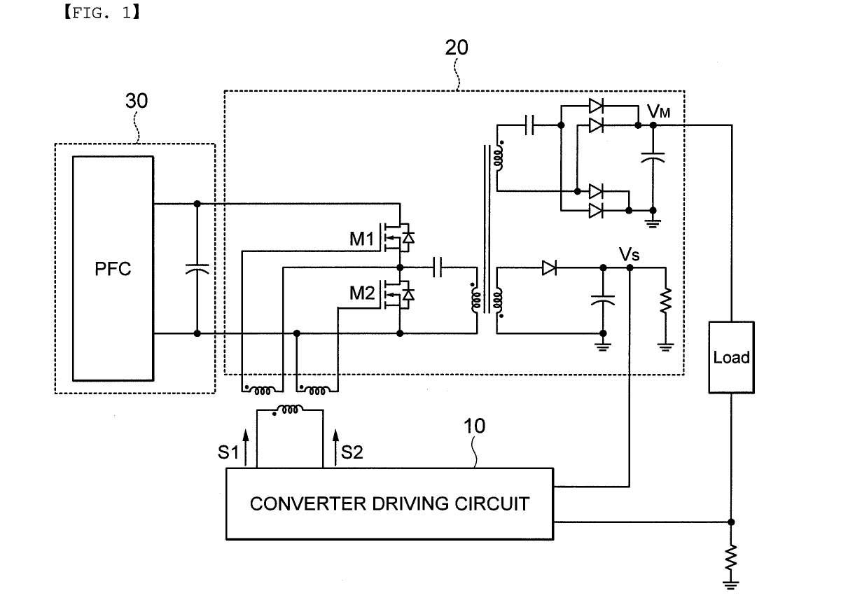

FIG. 1 is a circuit diagram of a dual-mode LLC resonant converter system according to an embodiment of the present invention.

Referring to FIG. 1, the dual-mode LLC resonant converter system according to the present embodiment may largely include a power supply unit 30, a dual-mode LLC resonant converter 20, and a converter driving circuit 10.

The power supply unit 30 may include a power factor correction (PFC) that is widely used in general.

The dual-mode LLC resonant converter 20 may include a first switch M1 and a second switch M2 that are installed at a primary side and may include a master stage and a slave stage at a secondary side.

The converter driving circuit 10 receives an output voltage of the dual-mode LLC resonant converter 20 as feedback, generates switch control signals S1 and S2 that are optimized according to a change in the output voltage, and applies the switch control signals S1 and S2 to the first switch M1 the second switch M2, respectively.

As shown in FIG. 1, the switch control signals S1 and S2 may be respectively connected to control terminals of the first switch M1 and the second switch M2 of the dual-mode LLC resonant converter 20 through a transformer, thereby obtaining insulation between the converter driving circuit 10 and the dual-mode LLC resonant converter 20 and reducing power consumption compared to a case where the switch control signals S1 and S2 are connected directly to the control terminals.

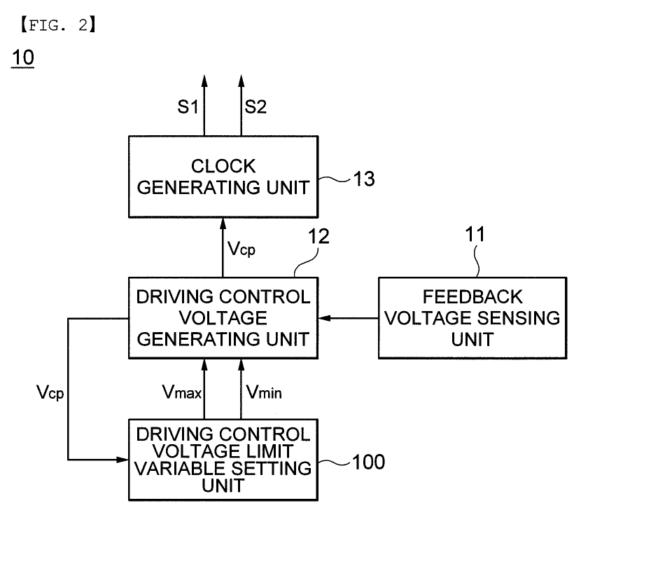

FIG. 2 is a block diagram of the converter driving circuit 10, according to an embodiment of the present invention.

Referring to FIG. 2, the converter driving circuit 10 may include a feedback voltage sensing unit 11, a driving control voltage generating unit 12, a setting unit 100 for setting a variable limit of a driving control voltage (hereinafter, referred to as a ‘driving control voltage limit variable setting unit 100’), and a clock generating unit 13.

The feedback voltage sensing unit 11 may feedback a voltage output from the dual-mode LLC resonant converter 20 to the driving control voltage generating unit 12 and may be embodied as a general sensing resistor or the like.

The driving control voltage generating unit 12 receives the feedback voltage and generates a driving control voltage Vcp for adjusting a duty ratio of the first switch M1 and the second switch M2 of the dual-mode LLC resonant converter 20.

The driving control voltage generating unit 12 generates the driving control voltage Vcp that is variably determined within a predetermined range.

The driving control voltage limit variable setting unit 100 is connected to the driving control voltage generating unit 12 and generates an upper limit voltage Vmax and a lower limit voltage Vmin that limit the variable range of the driving control voltage Vcp.

In this case, the driving control voltage limit variable setting unit 100 reflects the driving control voltage Vcp when the upper limit voltage Vmax and the lower limit voltage Vmin are generated.

The clock generating unit 13 is connected to the driving control voltage generating unit 12, receives the driving control voltage Vcp, and generates the switch control signals S1 and S2 for respectively controlling on/off of the first switch M1 and the second switch M2 of the dual-mode LLC resonant converter 20.

FIG. 3 is a block diagram of the driving control voltage limit variable setting unit 100 according to an embodiment of the present invention.

Referring to FIG. 3, the driving control voltage limit variable setting unit 100 may include a control current generating unit 110, a reference current generating unit 120, a control frequency signal generating unit 130, a reference frequency signal generating unit 130′, a phase-frequency comparing unit 140, a limit determining voltage generating unit 150, and a limit voltage generating unit 160.

The limit voltage generating unit 160 receives a limit determining voltage Vc output from the limit determining voltage generating unit 150 and generates and outputs the upper limit voltage Vmax and the lower limit voltage Vmin by reflecting a change in the limit determining voltage Vc.

In this case, the limit determining voltage Vc is fed back to the control current generating unit 110. In addition, the control current generating unit 110 generates a control current I_{D} that varies according to a change in the limit determining voltage Vc.

The reference current generating unit 120 generates and outputs a reference current I_{R} to which a change in the limit determining voltage Vc is not reflected, unlike the control current generating unit 110.

The control frequency signal generating unit 130 and the reference frequency signal generating unit 130′ receive the control current I_{D} and the reference current I_{R}, compares the control current I_{D} and the reference current I_{R} with the driving control voltage Vcp, and generates a control frequency signal V_{FD} and a reference frequency signal V_{FR}, respectively.

The phase-frequency comparing unit 140 is connected to the control frequency signal generating unit 130 and the reference frequency signal generating unit 130′, compares the control frequency signal V_{FD} and the reference frequency signal V_{FR} in terms of the phase and frequency, and outputs the phase-frequency comparison result.

The limit determining voltage generating unit 150 is connected to the phase-frequency comparing unit 140 and generates the limit determining voltage Vc according to the phase-frequency comparison result.

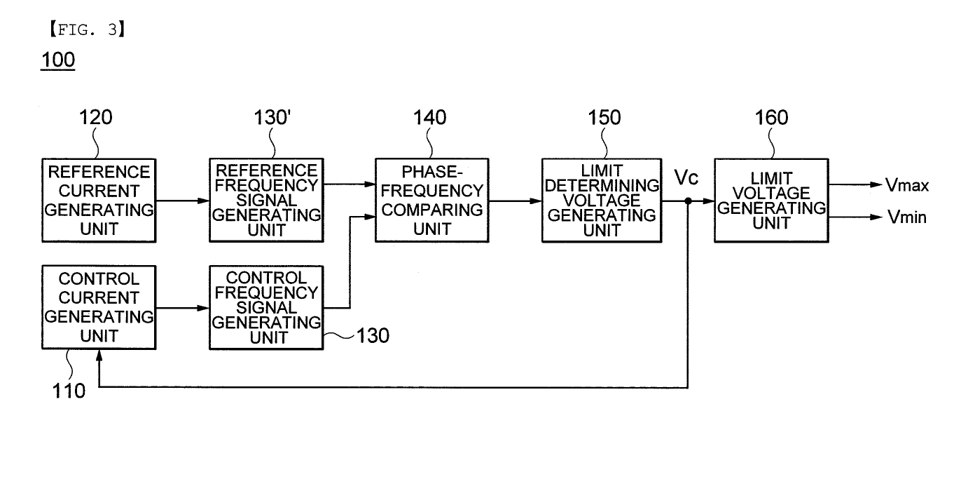

FIG. 4 is a circuit diagram of the control current generating unit 110 according to an embodiment of the present invention.

Referring to FIG. 4, the control current generating unit 110 may include a first transistor Q1, a first resistor RGT1, a second resistor RGT2, a second transistor M11, a first amplifier Amp1, a third resistor RGT, and a first current mirror CM1.

The first transistor Q1 is disposed between the first resistor RGT1 and the second resistor RGT2. The limit determining voltage Vc is applied to a control terminal of the first transistor Q1.

A second terminal of the second transistor M11 is connected to one end of the first current mirror CM1 and a first terminal of the second transistor M11 is connected to the other end of the first resistor RGT1 and one end of the third resistor RGT.

A first reference voltage Vr1 is applied to a first terminal of the first amplifier Amp1. A second terminal of the first amplifier Amp1 is connected to the second terminal of the second transistor M11. In addition, an output terminal of the first amplifier Amp1 is connected to a control terminal of the second transistor M11.

Accordingly, the control current generating unit 110 may receive the limit determining voltage Vc, may compare the limit determining voltage Vc with the first reference voltage Vr1, and may output the control current I_{D} that is generated according to the comparison result through the first current mirror CM1.

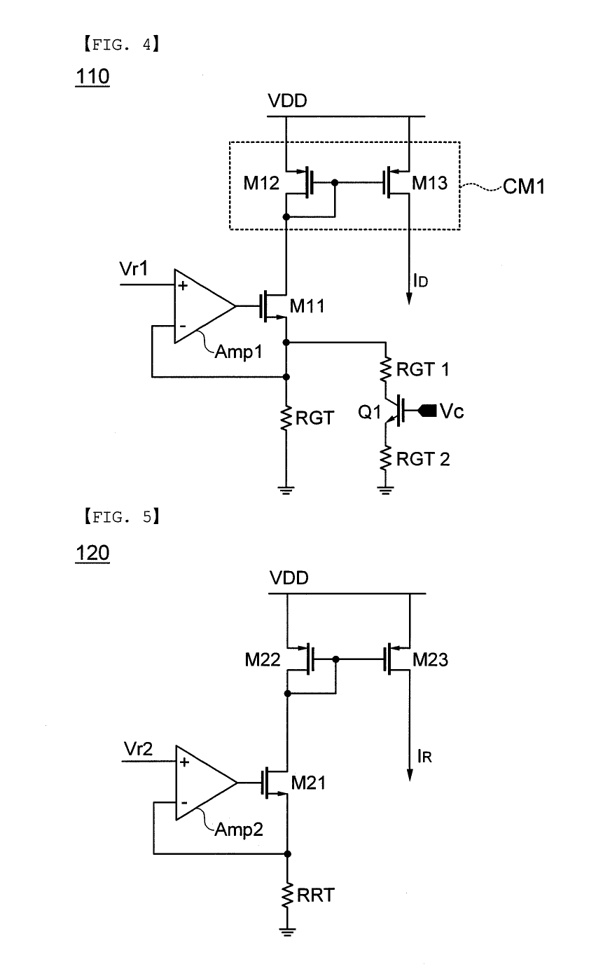

FIG. 5 is a circuit diagram of the reference current generating unit 120 according to an embodiment of the present invention.

Referring to FIG. 5, the reference current generating unit 120 generates and outputs the reference current I_{R} that is determined according to a fourth resistor RRT, a transistor M21, and a preset second reference voltage Vr2.

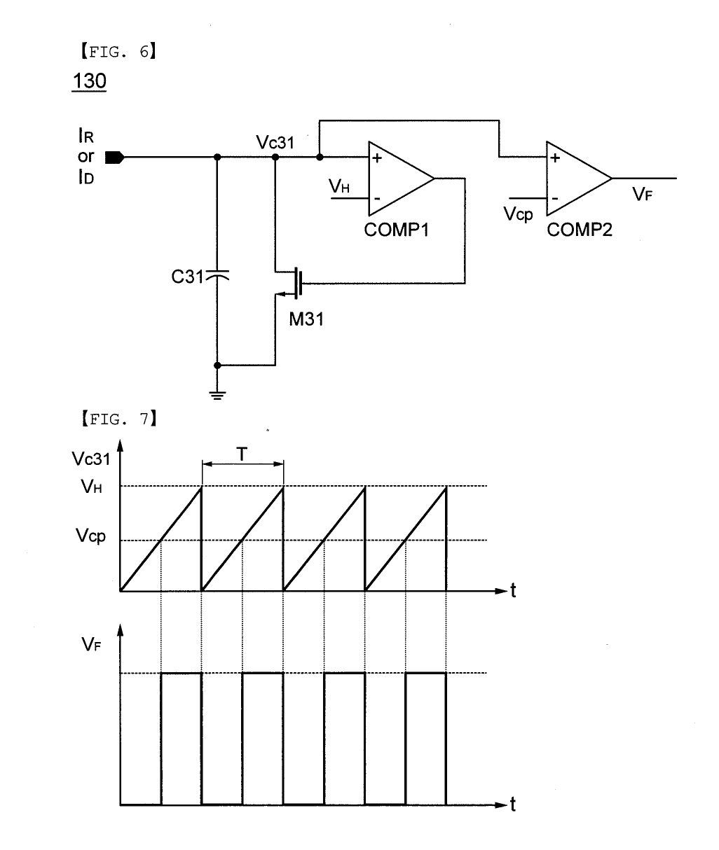

FIG. 6 is a circuit diagram of a frequency signal generating unit 130 according to an embodiment of the present invention. FIG. 7 is a diagram for describing an operating principle of a circuit of FIG. 6, according to an embodiment of the present invention.

Referring to FIG. 6, the frequency signal generating unit 130 may receive the reference current I_{R} through an input terminal and may output a reference frequency signal V_{FR} or may receive the control current I_{D} through the input terminal and may output the control frequency signal V_{FD}.

A first capacitor C31 is connected between the input terminal and a ground terminal and applies a voltage value Vc31 dependent upon an input current to a non-inverting terminal of a first comparator COMP1. In addition, a predetermined upper limit value V_{H} is applied to an inverting terminal of the first comparator COMP1.

In this case, a first terminal of a third transistor M31 is connected to one end of the first capacitor C31 and a second terminal of the third transistor M31 is grounded. An output terminal of the first comparator COMP1 is connected to a control terminal of the third transistor M31.

Accordingly, as a reference current or a control current is charged into the first capacitor C31, the voltage value Vc31 increases. When the reference current reaches the predetermined upper limit value V_{H}, the third transistor M31 is turned on such that a voltage charged into the first capacitor C31 is removed and the voltage value Vc31 reduces to 0, which is repeated as shown in FIG. 7.

The voltage value Vc31 is also connected to a non-inverting terminal of a second comparator COMP2. In this case, as the driving control voltage Vcp is applied to an inverting terminal of the second comparator COMP2, the voltage value Vc31 and the driving control voltage Vcp are compared with each other and a frequency signal V_{F} of a square wave type is output to an output terminal of the second comparator COMP2, as shown in FIG. 7.

As described above, a change in the limit determining voltage Vc is not reflected to the reference current I_{R} and the reference current I_{R} is maintained constant to a predetermined value. The control current I_{D} has properties whereby the size and frequency thereof vary according to a change in the limit determining voltage Vc.

In addition, since the reference frequency signal V_{FR} and the control frequency signal V_{FD} are generated according to the comparison with the driving control voltage Vcp, a change in the driving control voltage Vcp is reflected to the reference frequency signal V_{FR} and the control frequency signal V_{FD}.

Accordingly, the reference frequency signal V_{FR} has properties to which only a change in the driving control voltage Vcp is reflected. The control frequency signal V_{FD} has properties to which both a change in the limit determining voltage Vc and a change in the driving control voltage Vcp are reflected.

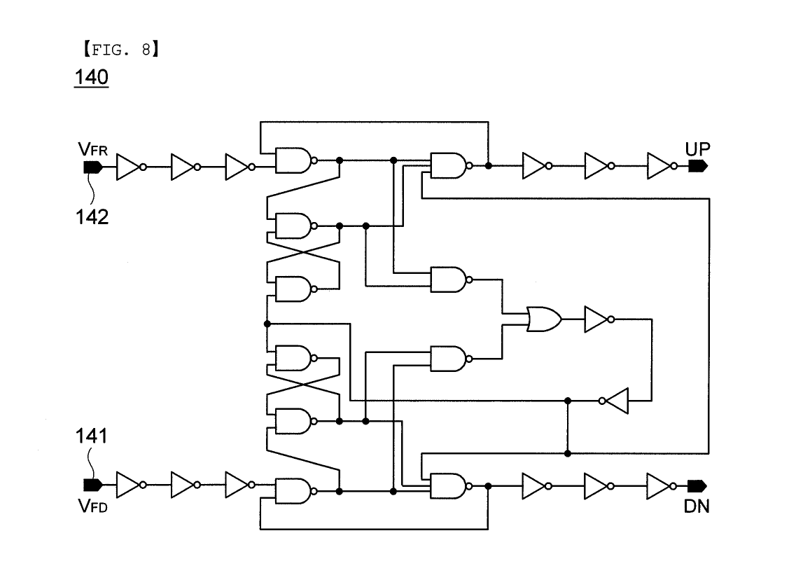

FIG. 8 is a circuit diagram of the phase-frequency comparing unit 140 according to an embodiment of the present invention.

Referring to FIG. 8, the phase-frequency comparing unit 140 may include a first input terminal to which the control frequency signal V_{FD} is input, a second input terminal to which the reference frequency signal V_{FR} is input, a first output terminal UP, and a second output terminal DN.

In this case, the phase-frequency comparing unit 140 (which is also referred to as a phase frequency detector (PFD)) including a combination of a plurality of logic devices, which is a well-known member for comparing a phase and frequency of a signal, and thus, the details thereof will be omitted.

When a reference frequency is greater than a control frequency, a high signal is output to the first output terminal UP by as much as a relative difference between a phase and a frequency. When the control frequency is greater than the reference frequency, a high signal is output to the second output terminal DN by as much as a difference between a phase and a frequency.

When a signal of the first output terminal UP is changed from high to low, a signal of the second output terminal DN is instantly generated as a high signal, which is a reset delay that occurs due to an internal reset signal.

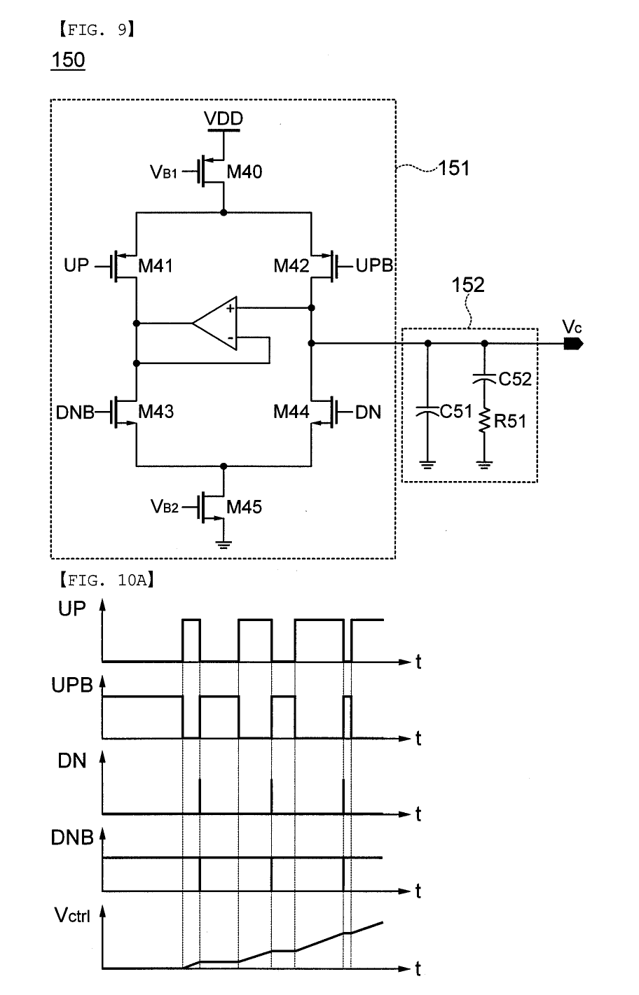

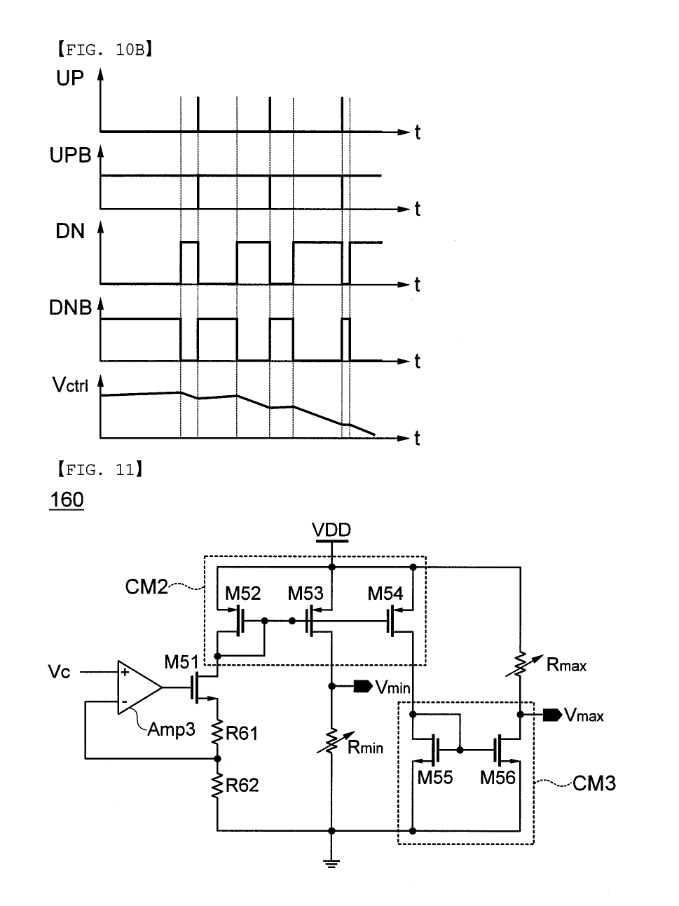

Output signals of the first output terminal UP and the second output terminal DN of the phase-frequency comparing unit 140 are confirmed with reference to FIGS. 10A and 10B.

FIG. 9 is a circuit diagram of the limit determining voltage generating unit 150 according to an embodiment of the present invention. FIGS. 10A and 10B are diagrams for describing a generating principle of the limit determining voltage Vc, according to an embodiment of the present invention.

Referring to FIGS. 9, 10A, and 10B, the limit determining voltage generating unit 150 generates the limit determining voltage Vc in such a manner that the limit determining voltage Vc is increased while a high signal is applied to the limit determining voltage generating unit 150 from the first output terminal UP of the phase-frequency comparing unit 140 and the limit determining voltage Vc is reduced while a high signal applied to the limit determining voltage generating unit 150 from the second output terminal DN of the phase-frequency comparing unit 140.

As shown in FIG. 9, the limit determining voltage generating unit 150 may be embodied by a well-known charge pump (CP) 151 and a well-known loop filter (LP) 152.

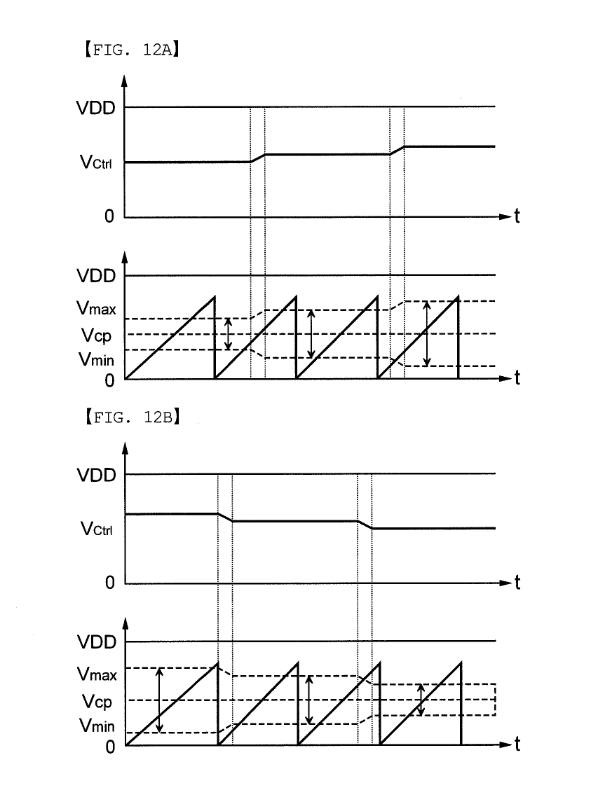

FIG. 11 is a circuit diagram of the limit voltage generating unit 160 according to an embodiment of the present invention. FIGS. 12A and 12B are diagram for describing a generating principle of a limit voltage, according to an embodiment of the present invention.

Referring to FIG. 11, the limit voltage generating unit 160 may include a third amplifier Amp3, a fourth transistor M51, a fifth resistor R61, a sixth resistor R62, a seventh resistor Rmin, an eighth resistor Rmax, a second current mirror CM2, and a third current mirror CM3.

The limit determining voltage Vc is applied to a first terminal of the third amplifier Amp3. An output terminal of the third amplifier Amp3 is connected to a control terminal of the fourth transistor M51.

A first terminal of the fourth transistor M51 is connected to the fifth resistor R61. The fifth resistor R61 is connected to the sixth resistor R62.

In this case, a connection node of the fifth resistor R61 and the sixth resistor R62 is connected to a second terminal of the third amplifier Amp3.

A second terminal of the fourth transistor M51 is connected to one end of the second current mirror CM2. A first another end of the second current mirror CM2 is connected to the seventh resistor Rmin. A second another end of the second current mirror CM2 is connected to one end of the third current mirror CM3.

The other end of the third current mirror CM3 is connected to the eighth resistor Rmax.

The lower limit voltage Vmin may be output from a node between the first another end of the second current mirror CM2 and the seventh resistor Rmin. The upper limit voltage Vmax may be output from a node between the eighth resistor Rmax and the other end of the third current mirror CM3.

Accordingly, the limit voltage generating unit 160 may generate a limit voltage in such a manner that the upper limit voltage Vmax is increased and the lower limit voltage Vmin is reduced when the limit determining voltage Vc is increased, and the upper limit voltage Vmax is reduced and the lower limit voltage Vmin is increased when the limit determining voltage Vc is reduced.

That is, when a difference in frequency is greatly generated, the limit determining voltage Vc is increased and a width between the upper limit voltage Vmax and the lower limit voltage Vmin is increased. When a difference in frequency is relatively small, the limit determining voltage Vc is reduced and the width between the upper limit voltage Vmax and the lower limit voltage Vmin is reduced.

Since the driving control voltage Vcp is changed according to a relative frequency difference between the upper limit voltage Vmax and the lower limit voltage Vmin, a range of a change in the driving control voltage Vcp is adjusted. In addition, since the range of a change in the driving control voltage Vcp is adjusted, the efficiency or stability of a dual-mode LLC converter may be increased.

In a method of driving a dual-mode LLC resonant converter according to an embodiment of the present invention, a range of a change in the driving control voltage Vcp may be limited to a range between the upper limit voltage Vmax and the lower limit voltage Vmin that vary according to a change in the driving control voltage Vcp so as to drive the dual-mode LLC resonant converter.

In this case, the upper limit voltage Vmax and the lower limit voltage Vmin are determined according to the limit determining voltage Vc. In this regard, the limit determining voltage Vc may be generated by comparing the control current I_{D} to which a change in the limit determining voltage Vc is reflected with the driving control voltage Vcp to generate the control frequency signal V_{FD} and then comparing phase differences and frequencies of a preset reference frequency and a control frequency with each other.

In this case, the reference frequency signal V_{FD} may compare the reference current I_{R} that is generated regardless of a change in the limit determining voltage Vc with the driving control voltage Vcp and may generate the reference current I_{R}.

In addition, the limit determining voltage Vc may be generated by a PLL loop.

As described above, since a variable range of a driving control voltage may be adjusted according to a change in feedback voltage and frequency, system efficiency may be increased and system stability may also be increased compared to a conventional dual-mode LLC converter.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A converter driving circuit for driving a dual-mode LLC resonant converter, the converter driving circuit comprising:
a feedback voltage sensing unit that feed-back a voltage output from the dual-mode LLC resonant converter;
a driving control voltage generating unit that is connected to the feedback voltage sensing unit and generates a driving control voltage by using the feedback voltage;
a driving control voltage limit variable setting unit that is connected to the driving control voltage generating unit and generates an upper limit voltage and a lower limit voltage that limit a variable range of the driving control voltage; and
a clock generating unit that is connected to the driving control voltage generating unit, receives the driving control voltage, and generates switch control signals for respectively controlling on/off of switches of the dual-mode LLC resonant converter,
wherein the upper limit voltage and the lower limit voltage vary by reflecting a change in the driving control voltage.

2. The converter driving circuit according to claim 1, wherein the driving control voltage limit variable setting unit includes:
a limit voltage generating unit that receives a limit determining voltage and generates the upper limit voltage and the lower limit voltage;
a control current generating unit that receives the limit determining voltage as feedback and generates a control current;
a control frequency signal generating unit that is connected to the control current generating unit, compares the control current with the driving control voltage, and generates a control frequency signal;
a reference frequency signal generating unit that generates a reference frequency signal; and
a limit determining voltage controller that is connected to the control frequency signal generating unit and the reference frequency signal generating unit, compares the control frequency signal with the reference frequency signal, and adjusts the limit determining voltage.

3. The converter driving circuit according to claim 2, wherein the driving control voltage limit variable setting unit further includes a reference current generating unit that is connected to the reference frequency signal generating unit and generates a reference current regardless of a change in the limit determining voltage, and
wherein the reference frequency signal generating unit compares the reference current output from the reference current generating unit with the driving control voltage, and generates a reference frequency signal.

4. The converter driving circuit according to claim 3, wherein the limit determining voltage controller includes:
a phase-frequency comparator that receives each of the control frequency signal and the reference frequency signal, compares phase differences and frequencies of the control frequency signal and the reference frequency signal each other, and outputs the comparison result; and
a limit determining voltage generating unit that receives a signal output from the phase-frequency comparator and generates the limit determining voltage.

5. The converter driving circuit according to claim 4, wherein the phase-frequency comparator includes:
a first input terminal connected to the control frequency signal generating unit;
a second input terminal connected to the reference frequency signal generating unit;
a first output terminal that outputs a high signal by as much as a relative difference between a phase and a frequency when a reference frequency is greater than a control frequency; and
a second output terminal that outputs a high signal by as much as a relative difference between a phase and a frequency when a reference frequency is smaller than a control frequency.

6. The converter driving circuit according to claim 5, wherein the limit determining voltage generating unit increases the limit determining voltage while the high signal is applied from the first output terminal, and reduces the limit determining voltage while the high signal is applied from the second output terminal.

7. The converter driving circuit according to claim 2, wherein the limit voltage generating unit increases the upper limit voltage and reduces the lower limit voltage when the limit determining voltage increases, and reduces the upper limit voltage and increases the lower limit voltage when the limit determining voltage reduces.

8. The converter driving circuit according to claim 7, wherein the limit voltage generating unit includes:
a third amplifier having a first terminal to which the limit determining voltage is applied;
a fourth transistor having a control terminal to which an output terminal of the third amplifier is connected;
a fifth resistor having one end connected to a first terminal of the fourth transistor, and the other end connected to a second terminal of the third amplifier;
a sixth resistor having one end connected to the other end of the fifth resistor, and the other end that is grounded;
a second current mirror having one end connected to the second terminal of the fourth transistor, and a first another end to which a terminal for outputting the lower limit voltage is connected;
a third current mirror having one end connected to a second another end of the second current mirror, and the other end connected to a terminal for outputting the upper limit voltage;
a seventh resistor having one end connected to the first another end of the second current mirror, and the other end that is grounded; and
an eighth resistor having one end connected to the other end of the third current mirror.

9. The converter driving circuit according to claim 2, wherein the control current generating unit includes:
a first transistor having a control terminal to which the limit determining voltage is applied;
a first resistor having one end connected to a first terminal of the first transistor;
a second resistor having one end connected to a second terminal of the first transistor, and the other end that is grounded;
a second transistor having a first terminal to which the first resistor is connected;
a first amplifier having an output terminal connected to a control terminal of the second transistor, a first terminal to which a preset first reference voltage is applied, and a second terminal connected to the first terminal of the second transistor;
a third resistor having one end connected to the first terminal of the second transistor, and the other end that is grounded; and
a first current mirror having one end connected to a second terminal of the second transistor, and the other end for outputting the control current.

10. The converter driving circuit according to claim 2, wherein the control frequency signal generating unit includes:
an input terminal that receives the control current;
a first capacitor having one end connected to the input terminal, and the other end that is grounded;
a third transistor having a first terminal connected to one end of the first capacitor, and a second terminal that is grounded;
a first comparator having a first terminal connected to one end of the first capacitor, a second terminal to which a preset second reference voltage is applied, and an output terminal connected to a control terminal of the third transistor; and
a second comparator having a first terminal connected to one end of the first capacitor, a second terminal to which the driving control voltage is applied, and an output terminal for outputting the control frequency signal.

11. The converter driving circuit according to claim 3, wherein the reference frequency signal generating unit includes:
an input terminal that receives the reference current;
a first capacitor having one end connected to the input terminal, and the other end that is grounded;
a third transistor having a first terminal connected to one end of the first capacitor, and a second terminal that is grounded;
a first comparator having a first terminal connected to one end of the first capacitor, a second terminal to which a preset second reference voltage is applied, and an output terminal connected to a control terminal of the third transistor; and
a second comparator having a first terminal connected to one end of the first capacitor, a second terminal to which the driving control voltage is applied, and an output terminal for outputting the reference frequency signal.

12. A dual-mode LLC resonant converter system, comprising:
the converter driving circuit according to any one of claims 1 to 11;
a dual-mode LLC resonant converter that includes a switch for receiving a switch control signal output from the converter driving circuit; and
a power supply unit that supplies power to the dual-mode LLC resonant converter.

13. A method of driving a dual-mode LLC resonant converter, the method comprising:
feeding-back a voltage output from the dual-mode LLC resonant converter to generate a driving control voltage; and
controlling on/off of switches of the dual-mode LLC resonant converter by using the driving control voltage,
wherein a variable range of the driving control voltage is limited to a range between an upper limit voltage and a lower limit voltage varied by reflecting a change in the driving control voltage.

14. The method according to claim 13, wherein the upper limit voltage and the lower limit voltage are determined according to a limit determining voltage,
wherein the limit determining voltage is generated by:
comparing a control current to which a change in the limit determining voltage is reflected with the driving control voltage to generate a control frequency signal; and
comparing phase differences and frequencies of a preset reference frequency signal and the control frequency signal with each other.

15. The method according to claim 14, wherein the reference frequency signal is generated by comparing a reference current that is not related to the change in the limit determining voltage with the driving control voltage.

16. The method according to claim 15, wherein the limit determining voltage is generated by a PLL loop.

17. The method according to claim 15, wherein the upper limit voltage and the lower limit voltage vary in such a manner that the upper limit voltage is increased and the lower limit voltage is reduced when the limit determining voltage increases, and the upper limit voltage is reduced and the lower limit voltage is increased when the limit determining voltage is reduced.
